(19) United States
(12) Patent Application Publication
(10) Pub. No.: US 2013/0173387 A1
(43) Pub. Date: Jul. 4, 2013

(54) Method and system for marketing and sales promotion

(71) Applicant: Jesse D. Adelaar, New York, NY (US)

(72) Inventor: Jesse D. Adelaar, New York, NY (US)

(21) Appl. No.: 13/374,507

(22) Filed: Dec. 30, 2011

(51) Int. Cl. G06Q 30/02; G06Q 30/00

(52) U.S. Cl. 705/14.53; 705/26.9; 705/14.58; 705/14.64

(57) ABSTRACT

Marketing and sales promotion support is provided to a plurality of participating brick and mortar establishments by maintaining on a server a database of customers' shopping behavior. When a customer enters the premises of one of those establishments, promotional offerings are pushed from the server to a wireless mobile device, such as a smartphone, in the possession of the customer, the content of the offerings being determined from information in the database related to the customer's prior shopping behavior. The customer behavior during the current visitation is used to update the database information related to him.

### BACKGROUND OF THE INVENTION

The present invention relates generally to marketing systems and, more particularly, concerns a method and computerized system for enhanced marketing and information delivery, for example, in retail establishments and casinos.

In accordance with a traditional retail sales model, most customers entering a store simply look around and eventually just leave. While some retail establishments may keep records of purchases tied to a specific customer, many retailers simply process a transaction without gathering information on purchasing behavior. The exceptions are retailers with loyalty programs, which require a customer to fill out a form and give his information every time he makes a purchase.

Online retailers like amazon.com have the ability to monitor buyer behavior from the time that a potential customer enters the site to a final sale. This allows amazon.com to study a customer's behavior and recommend specific items, with the aim of increasing conversion. A recent Wall Street Journal article observed that conversion at amazon.com ran about 3% for a shopper using a personal computer, and it increased to 4-5% for a shopper using a mobile device, along with a 10-20% increase in average sales. The traditional sales model lacks this interaction and these benefits because it only observes buying behavior at the point of sale.

In addition, the traditional sales model has come under the assault of mobile applications that allow a consumer to scan barcodes on items in a store, check online prices, and purchase at competing online retailers.

FourSquare (foursquare.com) is a service that enables consumers with mobile devices to check in at numerous locations, including public spaces and commercial interests. Such a check-in is publicly broadcasted and, where applicable, FourSquare pushes coupons to customers for use with commercial interests with whom Foursquare has a marketing agreement. One of the problems with this service is that it does not record activity beyond visitations and coupon usage. In addition, it is likely that most potential consumers would prefer not to broadcast their whereabouts. Further, in order to check in to an establishment, a participating customer must launch an application, wait for the GPS to home in on his location, and select the establishment from a list of nearby landmarks. In order to be truly effective in a mass market, locating and checking in should place less demand on the customer, preferably, should be seamless, and allow the customer to opt out of broadcasting his location.

Groupon (groupon.com) is a service that negotiates discounts with popular businesses. Deals are pushed in email from the site to subscribers, or via push notifications on mobile applications. If interested in a deal, a recipient can participate, resulting in increased foot traffic at participating businesses. In practice, Groupon can be a great experience or a total disaster for a retailer, as anticipated demand is unknown at particular pricing points, since the data gathered by Groupon on buying activity is limited to Groupon purchases. This model relies primarily on using Groupon's ecosystem to introduce potential customers to a local business with the hopes of repeat business or purchases in addition to Groupon usage. It is likely that most local businesses actually lose money issuing Groupons.

Casino Rewards programs, as they exist today, are rather cumbersome. The casino gathers information from clients by having them fill out an application, which is then entered manually into the rewards system. Then, the client is issued a rewards card and is asked to hand that card to a pit boss when table gaming, or to insert the card into a slot machine, so that the casino can record gaming behavior. This allows the casino to analyze betting patterns to incentivize increased drop by providing promotions and incentives for clients to pay the casino a visit, such as complementary rooms, meals or other incentives.

The limitations of existing state of the art are fairly obvious. As with retail, casinos can only observe behavior if the client hands in a card or inserts it into a gaming machine. Collection of client information, such as name, address and other contact information, is also extremely cumbersome because it is currently done manually.

Casino credit, under the existing state of the art, is established by way of a separate application filed with a separate department at the casino. A customer will provide personal, credit and banking information to the casino. The casino will then verify the bank account and creditworthiness of the customer. For most intents and purposes, casino credit is a separate system from loyalty.

Broadly, it is an object of the present invention, (hereafter referred to as “invention” or “Gidepost” interchangeably) to provide a method and system for marketing and sales promotion for brick and mortar establishments which overcome the shortcomings of existing methods and systems. It is specifically contemplated that a customer's behavior and activities while in such an establishment be monitored and information thereon recorded from the moment the customer enters the store. It is further contemplated that customized promotions would be offered to a customer while in or in the vicinity of the establishment, based upon such previously recorded information, without requiring a visit to the point of sale.

In accordance with one aspect of the present invention, marketing and sales promotion support is provided to a plurality of participating brick and mortar establishments by maintaining on a server a database of customers' shopping behavior. When a customer enters the premises of one of those establishments, and upon optional registration by the customer, promotional offerings are pushed from the server to a wireless computerized mobile device or mobile device (smartphone, tablet or other) in the possession of the customer, the content of the offerings being determined from information in the database related to the customer's prior behavior. The customer's behavior during the current visitation is used to update the database information related to his shopping habits.

In accordance with another aspect of the present invention, a customer's scanning of a barcode, RFID, NFC or other identifying tag attached to a product in the establishment with his mobile device or an effort to communicate with a competitive establishment to obtain a better price are detected, and further promotional offers or prices that match or beat the competition are pushed from the server to his mobile device.

In accordance with another aspect of the present invention, a user entering an establishment registers using RFID, NFC, or other identifying tag attached to the GidePost ecosystem (hereafter referred to as “GidePost Contact Point”. That registration first determines if the GidePost ecosystem has interacted with the customer before. If not, an application that will be used to implement various other aspects of the present invention is downloaded. If so, the application previously downloaded may be activated, or some other action taken, such as establishing a connection to the local retailer's wireless network, or automatically pushing certain offers to the customer, or other action.

In another embodiment, the user entering an establishment registers using the GidePost Contact Point. If the user or device has not previously connected to the GidePost ecosystem or visited the retail location, the system will cause the device to connect to the establishment's Wifi network and download an application program (if needed), optionally first seeking permission from the user. Preferably, if the user is known to the ecosystem, the application will connect to the establishment's Wifi network and may be used to implement other aspects of the present invention as described at other points in this document.

Further pertaining to the present invention, interaction GidePost Contact Point and the mobile device can provide temporary secure access to a commercial interest's (retail or other) WiFi network. Once the customer leaves, the mobile device would “forget” the network settings in order to maintain security of the network. In this specific application, only checking in to the GidePost Contact Point would enable connection to the on-site WiFi.

In accordance with another aspect of the invention, related purchases in other establishments that belong to the GidePost ecosystem made by the customer are used to ascertain the best offers to push to him for related products and services.

### BRIEF DESCRIPTION OF THE DRAWINGS

The foregoing brief description and further objects, features and advantages of the present invention will be understood more completely from the following detailed description of a presently preferred, but nonetheless illustrative, embodiment in accordance with the present invention, with reference being had to the accompanying drawings, in which:

FIG. 1 is a block diagram of a system embodying the present invention;

FIG. 2 is a flow chart useful in describing the operation of a customer's mobile device in accordance with an embodiment of the present invention; and

FIG. 3 is a flow chart illustrating the operation of a server in accordance with an embodiment of the present invention when dealing with communication from a customer.

### DETAILED DESCRIPTION

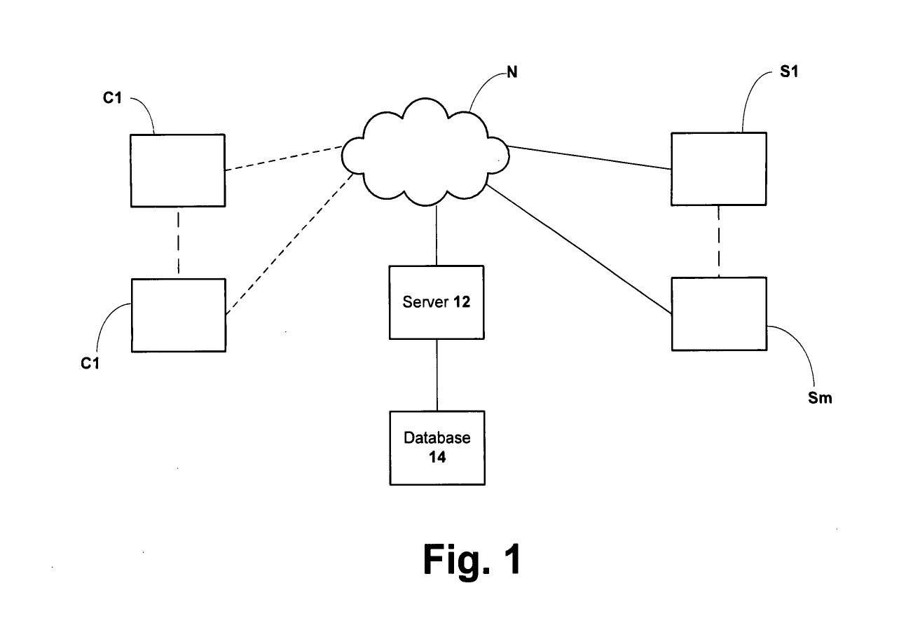

Turning now to the drawings, FIG. 1 is a block diagram of a system 10 embodying the present invention. A plurality, n, of customers are connected to a network N, such as the Internet, via respective mobile devices C1 . . . Cn, the broken line connections to network N representing a wireless connection. Also connected to the network are a plurality, m, of subscribers through their respective computers S1 . . . Sm. For convenience, participants in system 10 will be referred to with the same reference characters as their communication apparatus for accessing the network. For example, “C1” will be used interchangeably to refer to both a customer and his mobile device, and “S1” will be used interchangeably to refer to both a subscriber and his computer. The subscribers may be retail establishments, casinos, or any business seeking to sell goods or services to customers C1 . . . CN. They become subscribers by registering for a marketing service making use of the present invention and paying membership fees and fees for services. A server 12, also connected to network N, assists subscribers S1 . . . Sm in marketing and promoting their goods and services. This server permits registration of subscribers and interfaces with them to provide services discussed further below. It also interfaces with customers C1 . . . Cn to provide marketing and promotional communications on behalf of the subscribers. Server 12 creates and manages the database 14, which will be discussed further below.

The mobile devices C1 . . . CN are preferably a Smartphone, tablet or other highly portable device, such as “Android” or “iPhone” devices connected to network N via a cellular telephone system. However, they may also be a WiFi enabled device or a device combining both. It is preferred that subscribers offer a WiFi hotspot on their premises for use by mobile devices mobile devicemobile deviceCl . . . CN, as will be discussed further below.

Mobile devices C1 . . . CN run a marketing application or “app” hereafter referred to as “GidePost” (collectively including a Gidepost branded or a white label app connecting to the GidePost ecosystem), which senses when a customer enters a subscriber's premises. In the simplest case, such sensing could be done by generating a signal at the customer premises which is detected by GidePost. GidePost then contacts server 12 which, via shopping history information about the customer maintained in database 14, determines what goods or services available at the subscriber's premises might be of interest to the customer. Server 12 then pushes available promotions for those goods and services to the customer's mobile device. In addition, for any such customer, server 12 can also generate customized promotions that have been authorized by the subscriber.

Alternatively, if the consumer is not known to the retailer, GidePost then causes the mobile device to connect to the network and download the application that will be used for other aspects of the present invention. Whether the customer is known to the retailer or not, the consumer will preferably be asked to approve being connected to the retailer's WiFi network.

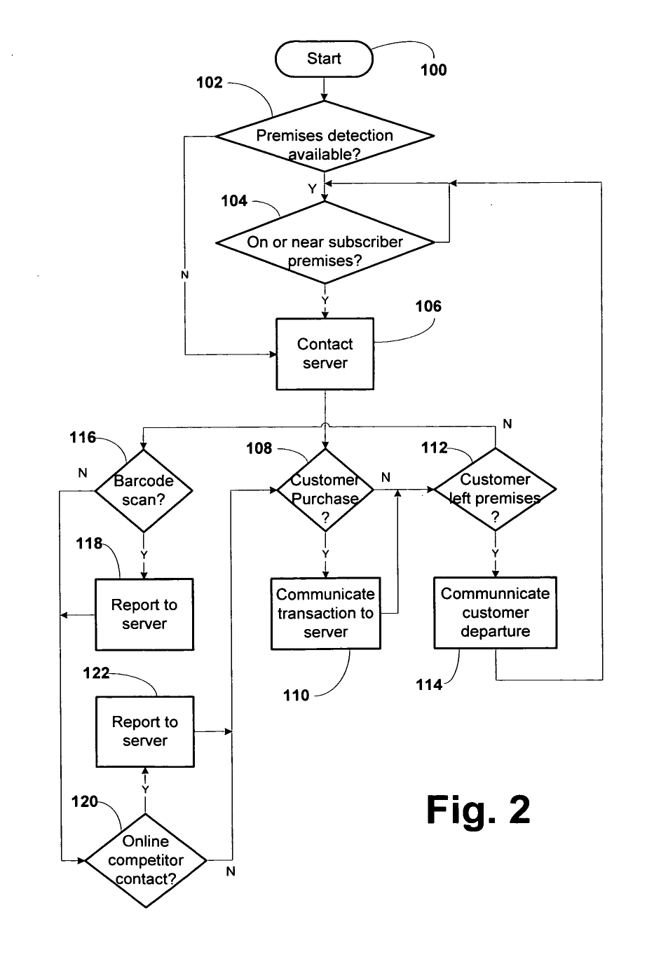

FIG. 2 is a flow chart useful in describing the operation of a mobile device running the GidePost application. The process begins at block 100 and, at block 102 a test is performed to determine whether the mobile device has premises detection capability (NFC, RFID, or background GPS). Most mobile devices will have this capability, resulting in control being transferred to block 104, where the system awaits an indication that the customer is on or near subscriber premises. Control then transfers to block 106, where GuidePost causes the mobile device to contact server 112 to report what premises the customer is on. On the other hand, if it is determined at block 102 that the mobile device has no premises detection capability the customer must sign in to GidePost and inform it of his location via GPS or manual input. Control is then transferred to block 106.

In response to the communication at block 106, server 12 will begin to push to the customer's mobile device the promotions discussed above.

Today, many cellular telephones and other mobile devices contain a global positioning system (GPS) transmitter, which allows a customer's location to be tracked closely. When a customer is in the vicinity of subscriber's premises, GidePost can cause promotions to push to the customer's device, even before he reaches the premises with the hope of drawing a customer onto the premises even when he was not intending to go there. In the case of a casino, a customer may enter a casino property for any number of reasons besides gaming, be it a show, a drink, or just to look at a new property. Gidepost aims to enable promotions to be pushed to his mobile device with the hopes of enticing him to the gaming area, or even to engage in on-premises mobile gaming, once he is on site. On the other hand, if a customer has a mobile device with relatively crude technical features, he may still benefit from GidePost by simply signing in when he reaches particular premises.

When a customer makes a purchase or other transaction, the subscriber forwards the relevant transaction information to server 12 for update of database 14 with respect to the customer. However, from information provided by GidePost, it can also be determined when the customer leaves a subscriber's premises without making a purchase. This is very relevant information that can be forwarded to server 12, added to the customer's database information, and utilized in formulating future promotions for the customer, making it more likely to convert the customer from a window shopper to an actual purchaser in the future.

Returning to FIG. 2 to detail how GidePost achieves the above operations, a test is performed at block 108 to determine whether the customer has made a purchase. If so, control transfers the block 110 where GidePost causes the customer's device to communicate the occurrence of the transaction to server 12, after which control transfers to block 112. Thus the server knows that it should expect details from the subscriber, or can contact the subscriber to obtain the details. If the test at block 110 indicates that the customer has not made a purchase, control transfers to block 112, where a test is performed to determine if the customer has left the premises. If so, control transfers to block 114, with the customer's departure being communicated to server 12, and control is returned to block 104 to detect the customer's arrival at or near a subscriber's premises. If the customer's mobile device is incapable of premise detection, the customer will have to inform GuidePost that he left the premises, or GidePost will recognize it when the customer reports arrival at a new premises, or otherwise closes the Gidepost app. In either case, the process proceeds as discussed immediately above.

It should be appreciated that the present invention can provide a subscriber a much more accurate purchasing profile of a customer than it would otherwise have, since the invention produces a profile based upon purchases from all subscribers, not just purchases from an individual subscriber, which is the only information an individual subscriber would otherwise have available. One benefit of this is that, aside from pushing promotions based on the customer's overall purchasing behavior, promotions can be pushed to him based on his recent behavior. For example, if a customer has been shopping at building supply stores for tools and building supplies, promotions might be pushed to him for work shoes or work clothing at nearby establishments.

GidePost can sense when a customer scans the barcode, RFID, NFC or other identifier on a product and then causes the customer's mobile device to signal server 12, which can push to the customer's mobile device special offers or offers to match or beat competitor prices, including online prices, if authorized by the subscriber.

The retailer can also use the system to avoid loss of sales via competitive shopping, hereafter referred to the “Auto Price Match” system, or “APM”. Such methodology involves the retailer monitoring and parsing information transmitted over the retailer's network to and from the customer's device. By way of example only, one methodology for such monitoring and parsing is for the retailer network to use one or more of 1) the name of the website being visited and 2) the search string being used on that website. From one or both of these, it may be ascertained that the user is comparative shopping, which may trigger competitive offers to be sent to the user's device.

The retailer's network can compare the monitored, parsed data to the items sold in the store, and determine when the consumer is using the mobile device to check online for a better price than the price offered at that retail location. When this condition is detected, and if the APM detects that a lower price is being offered to the consumer, the system can then cause a matching, even better offer or lower price for that item to be sent to the consumer's mobile device.

In a still further embodiment, the retail establishment's system can, either manually or with human intervention, itself contact the website on which the user is attempting to find a lower price and can itself determine how to adjust its own offer. In this regard, when comparative shopping is detected, it can trigger a computer system to connect to the same website and determine what offers are available. Alternatively, it could trigger an email message to be sent to store personnel, preferable a salesperson with whom the consumer is interacting. Notably, because the establishment will know the identity of the consumer, and because the salesperson can enter the consumer's last name into his/her mobile device, the establishment can ascertain to which salesperson the message should be sent.

Preferably, the system should ask the consumer to consent to the monitoring of his communications, such as, for example, requiring him to acknowledge that any use of wireless capabilities within the store will be monitored.

GidePost will also allow a customer to pre-populate user information. Thus, when a rewards or loyalty card or credit line is requested, for instance, in a retail, casino or other commercial establishment, writing information by hand, manual entry into a computer, and even interaction with a person is no longer necessary. Alternatively, a customer can send an appropriate request to server 12 which, making use of database 14, can provide the necessary rewards card information needed by any subscriber and immediately request the card.

The present invention can be of great assistance when shopping in most retail establishments, for example, in a supermarket. GidePost includes an executable routine that allows a customer to create a shopping list. Database 14 contains a map of every subscriber's premises, including the location of all products. GuidePost forwards the shopping list to server 12 which, making use of a map of the subscriber's premises, re-orders the shopping list and generates directions to guide the customer through the premises so he can purchase every product on the shopping list with the least number of steps.

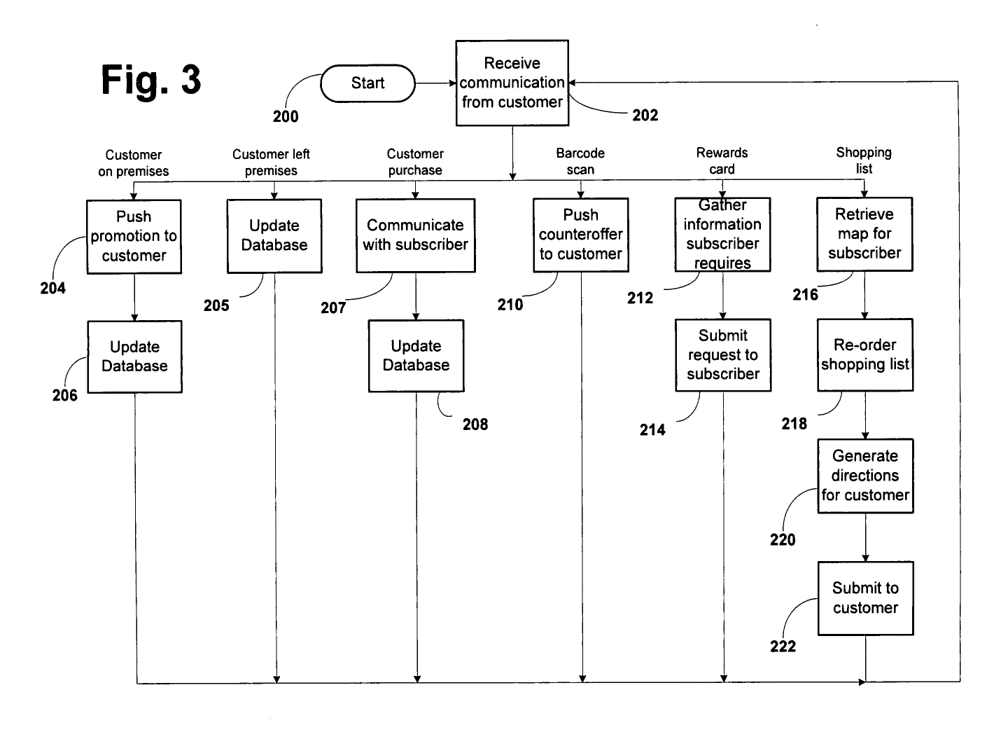

FIG. 3 is a flow chart illustrating the operation of server 12, in accordance with the present embodiment, when dealing with a customer. The process starts at block 200, and at block 202 the server receives a communication from a customer's mobile device. Further processing depends upon the nature of the communication. If the communication is a notification that the customer is on or near a subscriber's premises, control transfers to block 204, where the server pushes promotions to the customs mobile device via network N, based upon the customer's identity, the subscriber's identity and the customer's purchase history in database 14. Database 14 is then updated (block 206), and control reverts to block 202 to await a communication from customer.

If the communication from the customer is an indication that he has left a subscriber's premises on which he was present, control transfers from block 202 to block 204, where the database is updated with respect to that customer, to indicate that he left the subscriber premises without making a purchase. Control then reverts to block 202.

If the communication from the customer is an indication that he has made a purchase, the server communicates with the subscriber making the sale, via network N, to obtain the details of the transaction (block 206). The server then updates database 14 with respect to the customer to include information about the purchase (block two or eight), and control reverts to block 202.

If the customer communication is an indication that a barcode, NFC, RFID or other identifying scan has been made or a competitor contacted, control transfers to block to 210, where the server pushes a competitive counter-offer or offer to match the competitor's price to the customer's mobile device, via network N. Control then reverts to block 202.

If the customer communication is a rewards card request, control transfers to block to 212, where server 12 gathers from the database 14 the information that the particular subscriber requires. This information is then submitted via network N to the particular subscriber, with a request to open a rewards card account for the particular customer (block to 14). Control then reverts to block 202.

If the customer communication is a shopping list submission, control is transferred to block to 16, where server 12 retrieves a map of the customer's premises from database 14, reorders the customer's shopping list to obtain the shortest path through the subscriber's premises (block 218), and generates directions for the customer to make his way through the subscriber's premises (block 220). Those directions are then transferred to the customer's mobile device via network N (block 222), and control reverts to block 202. (Note: Map can also be pushed to show new products, or products that may be of interest to customer based on GidePost profile)

Although a preferred embodiment of the invention has been disclosed for illustrative purposes, those skilled in the art will appreciate that many additions, modifications, and substitutions are possible without departing from the scope and spirit of invention as defined by the accompanying claims.

What is claimed:

1. A method for providing marketing and sales promotion support to a plurality of participating brick and mortar establishments, comprising the steps of:
maintaining on a server a database of customers' shopping behavior;
when a customer enters the premises of one of the establishments, pushing at least one promotional offering related to the one establishment to a wireless, computerized mobile device in the possession of the entering customer, the content of the offering being determined from information in the database related to the customer's prior shopping behavior; and
updating the database based on the entering customer's behavior while on the premises.

2. The method of claim 1 further comprising, when the entering customer makes a purchase in the one establishment, communicating information related to the transaction to the server.

3. The method of claim 2 wherein the updating step comprises incorporating in the database information related to the purchase.

4. The method of claim 1 wherein one customer's mobile device includes means permitting the location of the one customer to be detected, the method further comprising the steps of:
detecting when the one customer is in the vicinity of a nearby establishment; and
pushing at least one promotional offering related to the nearby establishment to a wireless mobile device in the possession of the one customer.

5. The method of claim 4 wherein the content of the offering is based on the entering customer's behavior.

6. The method of claim 5 wherein the content of the offering is based on the entering customer's behavior in another establishment.

7. The method of claim 1 further comprising the steps of:
detecting when a customer scans with his mobile device a code or other identifier associated with a product or service offered for sale in the one establishment; and
pushing to the entering customer's mobile device at least one additional promotional offering related to the product or service with which the code is associated.

8. The method of claim 7 further comprising the steps of:
detecting when a customer utilizes his mobile device to contact a competitor; and
pushing to the entering customer's mobile device at least one additional promotional offering related to the product or service with which the code is associated.

9. The method of claim 1 further comprising the steps of:
detecting when a customer utilizes his mobile device to contact a competitor; and
pushing to the entering customer's mobile device at least one additional promotional offering related to the product or service with which the code is associated.

10. The method of claim 1 further comprising the steps of:
storing so as to be accessible to the server a map of all product locations in the premises;
transmitting from the entering customer's mobile device to the server a shopping list of products to be purchased at the one establishment;
at the server, re-ordering the shopping list based on the location of products on the premises so as to obtain the shortest path through the premises; and
generating directions for the one customer to traverse the premises along the shortest path.

11. The method of claim 1 wherein the entering customer is requested to approve being connected to a wireless network covering the premises.

12. The method of claim 1 wherein the content of the offering is based on the entering customer's recent behavior.

13. The method of claim 12 wherein the content of the offering is based on the entering customer's behavior in another establishment.

14. A method for providing marketing and sales promotion support to a plurality of participating brick and mortar establishments, comprising the steps of:
maintaining accessible to a server a map of all product locations on the premises of one of the establishments;
receiving at the server a shopping list of products to be purchased at the one establishment by one customer;
at the server, re-ordering the shopping list based on the location of products on the premises so as to obtain the shortest path through the premises; and
generating directions for the one customer to traverse the premises along the shortest path.

15. The method of claim 14 further comprising the step of transmitting the directions from the server to a mobile device in the possession of the entering customer.

16. A method for providing marketing and sales promotion support to a plurality of participating brick and mortar establishments, comprising the steps of:
providing one customer with a wireless mobile device including means permitting the location of the one customer to be detected;
detecting when the one customer is in the vicinity of one of the establishments; and
pushing at least one promotional offering related to the one establishment to the one customer's mobile device, the offering being designed to lure the customer into the establishment.

17. A method comprising registering a handheld mobile device at a location having a computer system, if the computer system does not recognize the mobile device, causing the device to connect to a wireless network at the location and download an application program, if the computer system recognizes the device, launching the application to connect to an application program for providing customized offers to a user of said mobile device.

18. The method of claim 17 further comprising prompting the user for permission to monitor wireless communications to and from the device.

19. The method of claim 17 further comprising monitoring said wireless communications.

20. The method of claim 18 further comprising comparing information parsed from said monitored communications with information indicative of items offered by said establishment to determine if a user is searching for items from another source, and if so, providing competing offers to said user based upon said communications.

21. The method of claim 19 further comprising detecting comparative shopping, and, in response thereto, sending a message to establishment personnel or connecting automatically to a remote computer system not associated with said establishment.
